(19) United States
(12) Patent Application Publication
(10) Pub. No.: US 2026/0125018 A1
(43) Pub. Date: May 7, 2026

(54) FASCIA INTEGRATED AGS

(71) Applicant: Magna Exteriors Inc., Aurora (CA)

(72) Inventors: Jeffrey Caraway, Oxford, MI (US); Martin R. Matthews, Troy, MI (US); Jeffrey B. Manhire, Rochester, MI (US); Sean E. Granger, Detroit, MI (US); Tyler D. Hamilton, Farmington, MI (US); Brandon Flis, Detroit, MI (US)

(21) Appl. No.: 19/379,145

(22) Filed: Nov. 4, 2025

Related U.S. Application Data
(60) Provisional application No. 63/717,111, filed on Nov. 6, 2024.

(51) Int. Cl. B60R 19/18; B60R 19/48

(52) U.S. Cl. CPC B60R 19/18; B60R 19/483; B60R 2019/1886; B60R 2019/486

(57) ABSTRACT

A fascia for a vehicle includes a main body having a fascia opening and multiple attachment or alignment structures, and an active shutter assembly including a bracket attached directly to the fascia via the attachment or alignment structures. The active shutter assembly also includes an actuator coupled to the bracket and a vane that is coupled to the bracket and to the actuator. The vane is located in or adjacent to the fascia opening and the actuator is operable to move the vane relative to the main body between a first position and a second position in which greater airflow is permitted through the fascia opening than when the vane is in the first position.

### REFERENCE TO RELATED APPLICATIONS

This application claims the benefit of U.S. Provisional Application Ser. No. 63/717,111 filed on Nov. 6, 2024 the content of which is incorporated herein by reference in its entirety.

### TECHNICAL FIELD

The present disclosure relates to a fascia with an integrated active vane.

### BACKGROUND

Vehicles include active shutter assemblies that prevent or allow airflow through a fascia of the vehicle to provide a desired aerodynamic effect or provide cooling air flow to components behind the fascia. The active shutter assemblies are carried on portions of the fascia that are separate from other portions and that define part of the outer surface of the fascia such that the fascia in the area of the active shutter assemblies is formed by multiple parts that define separate portions of the exterior of the fascia. So arranged, each part defining part of the exterior needs to have a class-A finish, the appearance of the different parts can negatively affect the fascia's overall appearance, and connection of the larger fascia parts to each other can be difficult and require significant framework.

### SUMMARY

In at least some implementations, a fascia for a vehicle includes a main body having a fascia opening and multiple attachment or alignment structures, and an active shutter assembly including a bracket attached directly to the fascia via the attachment or alignment structures. The active shutter assembly also includes an actuator coupled to the bracket and a vane that is coupled to the bracket and to the actuator. The vane is located in or adjacent to the fascia opening and the actuator is operable to move the vane relative to the main body between a first position and a second position in which greater airflow is permitted through the fascia opening than when the vane is in the first position.

In at least some implementations, the bracket is made of the same material as the main body, and the main body has an outer surface that is adapted to define part of an exterior of a vehicle and an inner surface on an opposite side of the main body from the outer surface, and wherein the bracket is welded to the inner surface of the main body.

In at least some implementations, the bracket and the main body include mating connection features that provide a snap-fit or interference fit connection by which the bracket is at least partially retained to the main body. The bracket may be welded to the main body at locations spaced from the mating connection features. In at least some implementations, a doghouse is formed on one of the main body or the bracket and a cooperating structure is formed on the other of the main body or the bracket, and a fastener is used at the doghouse to connect the bracket to the main body.

In at least some implementations, the main body and the bracket include overlapped flanges and the overlapped flanges are connected together via welding, an adhesive or a fastener.

In at least some implementations, the bracket includes a bracket opening aligned with the fascia opening, and the vane is pivotally connected to the bracket at the bracket opening so that an outer surface of the vane is visible through the fascia opening at least when the vane is in the first position. In at least some implementations, the actuator is coupled to the vane by a drive mechanism including a drive shaft and a linkage, and wherein the vane is coupled to one link of the linkage and the actuator is coupled to the drive shaft which is coupled to another link of the linkage so that, upon rotation of the drive shaft by the actuator, the linkage is driven to move the vane to and between the first position and second position.

In at least some implementations, the fascia opening is a first fascia opening and the main body includes a second fascia opening spaced from the first fascia opening, the vane is a first vane and the active shutter assembly includes a second vane coupled to the bracket, the first vane is arranged at the first fascia opening and the second vane is arranged at the second fascia opening, and the drive mechanism includes two linkages that are each coupled to the drive shaft and driven by the drive shaft as the drive shaft is rotated to move both the first vane and the second vane relative to the bracket and the main body.

In at least some implementations, the bracket includes a main wall received against an inner surface of the main body, the main wall includes a bracket opening that is aligned with the fascia opening such that the main wall surrounds the fascia opening, and wherein the vane overlaps the bracket opening and the vane is visible through the fascia opening. In at least some implementations, the bracket includes a base flange extending away from the main wall and a portion of the main body that is overlapped by the main wall, and wherein the main body includes flange oriented in the same direction as the base flange and wherein the base flange is connected to the flange of the fascia.

In at least some implementations, the linkage includes a driven arm connected to the drive shaft at a first location and to a second arm at a second location that is spaced from the first location, and wherein the second arm is connected to the vane at a third location, and wherein the driven arm and second arm are arranged so that, in the first position of the vane, the driven arm and second arm are substantially parallel to one another and arranged to resist movement of the vane away from the first position in the absence of rotation of the drive shaft by the actuator.

In at least some implementations, an electrically operated sensor is coupled to the bracket and arranged between part of the bracket and an inner surface of the main body.

In at least some implementations, the actuator is coupled to the vane by a drive mechanism including a drive shaft and a four-bar linkage mechanism in which the vane defines one bar of the mechanism and wherein two other bars of the mechanism are connected to the vane.

In at least some implementations, the main body includes a section in which the fascia openings are located, the section extends vertically above and below the fascia openings and across an entire cross-car extent of the main body and the section is formed in a single, continuous piece.

In at least some implementations, a fascia for a vehicle includes a main body and an active shutter assembly coupled to the main body. The main body includes multiple fascia openings and multiple attachment or alignment structures. The active shutter assembly includes a bracket attached directly to the fascia via the multiple attachment or alignment structures, one or more than one actuator, each of the one or more than one actuator being coupled to the bracket, and multiple vanes coupled to the bracket and to at least one of the one or more than one actuator. One or more of the multiple vanes are separately located in or adjacent to each of the multiple fascia openings, and one or more than one actuator is operable to move the multiple vanes relative to the main body between a first position and a second position in which greater airflow is permitted through the fascia opening than when the vane is in the first position.

In at least some implementations, the bracket includes multiple bracket openings defined in a main wall of the bracket and with each bracket opening aligned with a respective one of the multiple fascia openings and with the main wall surrounding each of the multiple fascia openings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present disclosure will become more fully understood from the detailed description and the accompanying drawings, wherein:

FIG. 1 is a front perspective view of a fascia for a vehicle including an active shutter assembly including active vanes shown in a closed position;

FIG. 2 is a front perspective view of the fascia showing the active vanes in an open position;

FIG. 3 is a rear perspective view of a portion of the fascia showing the active vanes, and a bracket by which the active vanes are attached to the fascia;

FIGS. 4 and 5 are perspective views showing one of the vanes in the closed position (FIG. 4) and the open position (FIG. 5), and a drive linkage by which the vane is driven between the closed and open positions;

FIG. 6 is a rear perspective view of the vane showing an embodiment of a drive linkage;

FIG. 7 is a side perspective view of the vane and drive linkage of FIG. 6; and

FIG. 8 is a perspective view showing the vanes and a drive linkage coupled to the vanes, with the vanes shown in their closed positions;

FIG. 9 is a perspective view showing the vanes and drive linkage of FIG. 8, with the vanes shown in their open positions;

FIGS. 10-21 are sectional views showing different connections of the bracket to the fascia;

FIG. 22 is a view of part of the rear of the fascia showing a sensor mounted to the frame between the two vanes; and

FIG. 23 is a sectional view showing an end seal portion of a vane and part of the frame.

### DETAILED DESCRIPTION

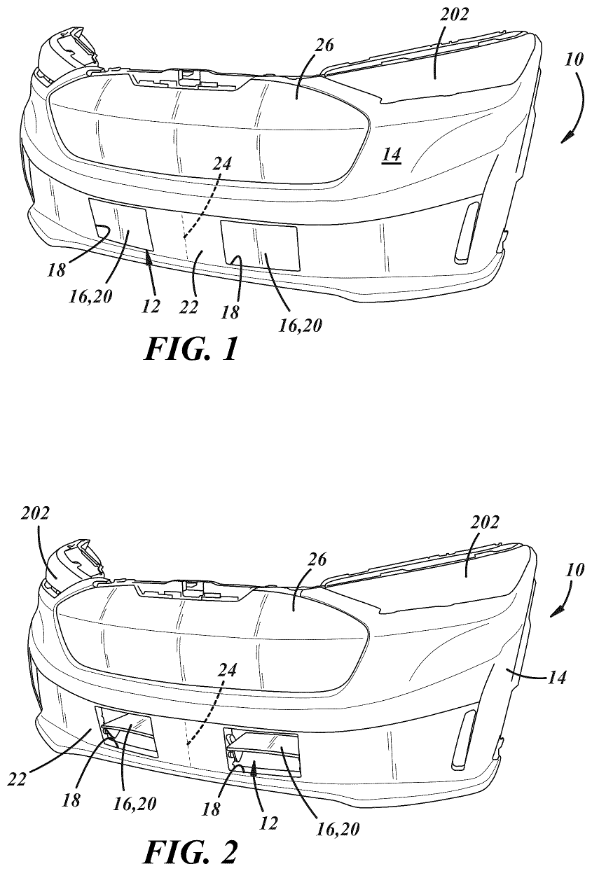

Referring in more detail to the drawings, FIGS. 1 and 2 show a fascia 10 for a front end of a vehicle. The fascia 10 includes an active shutter assembly 12 that is attached to a fascia main body 14. The active shutter assembly 12 includes one or more vanes 16 that are movable to and between a first or closed position, shown in FIG. 1, and a second or open position shown in FIG. 2. The vanes 16 are received in or adjacent to respective fascia openings 18 in the main body 14. In the closed position, the vanes 16 mostly or fully close the fascia openings 18 and inhibit or prevent airflow therethrough and in the open position, airflow through the fascia openings 18 and past the vanes 16 is more freely permitted.

Each vane 16 may have a peripheral shape that matches the shape of the respective fascia opening 18 at which the vane 16 is mounted. The outer surface 20 of each vane 16 may match the appearance (e.g. color and surface finish) of the outer surface 22 of the fascia main body 14, if desired. Further, in the closed position, the outer surface 20 of each vane 16 may be generally aligned and flush with the adjacent portion of the outer surface 22 of the fascia main body 14. In the open position, the vanes 16 are rotated or otherwise moved relative to the fascia openings 18 to permit airflow through the fascia openings. In at least some implementations, the outer surface 20 of each vane 16 when the vanes 16 are in the open position may be generally parallel to the airflow through the fascia openings 18, which may be generally perpendicular to the position of the vanes 16 when in the closed position. That is, the vanes 16 may be rotated by about ninety degrees between the closed and open positions, in at least some implementations.

While the drawings show two vanes 16, with one on each side of and evenly spaced from an imaginary centerline 24 of the fascia 10, multiple vanes 16 or shutters on each side of the fascia 10, such as but not limited to louvers or the like, can also be used. Further, the vanes 16 are shown in the drawings as being located below a grill section 26 of the fascia 10, where main grill section 26 extends across a majority of a cross-car dimension (where cross-car refers to directions between left and right sides of the vehicle) of the fascia main body 12 and across the centerline 24, although the vanes 16 may be located in, above or to the sides of the main grill section 26 in different implementations.

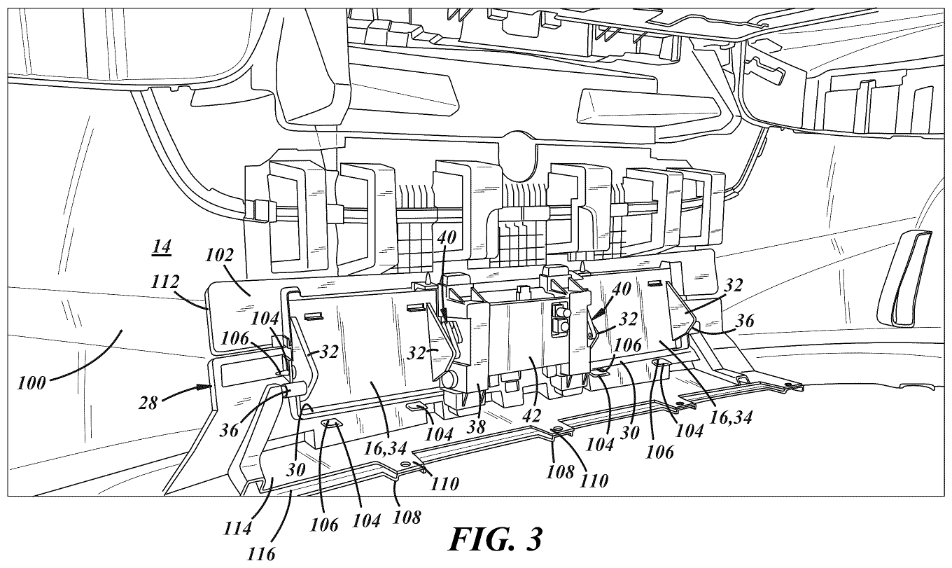

Referring to FIG. 3, the vanes 16 are mounted to a bracket 28 of the active shutter assembly 12, and the bracket 28 include bracket openings 30 that are aligned with the fascia openings 18 in the fascia main body 14. The bracket openings 30 may be larger than the fascia openings 18 and edges of the bracket 28 that define the bracket openings 30 can be offset or setback from the edges of the fascia openings 18 so that the bracket 28 is not or is less visible through the fascia openings 18 when the vanes 16 are moved from their closed positions. The vanes 16 may have one or more coupling flanges 32 that extend outwardly from a rear surface 34 of the vanes 16 and that are coupled to the bracket 28 at pivot points 36 (e.g. the vanes may include outwardly extending pins received in sockets defined in the bracket, or vice versa). The location of the connection between the bracket pivot points 36 and the coupling flanges 32 of the vanes 16 may be chosen to provide a desired movement of the vanes 16 from the closed position to the open position. The vanes 16, along all or part of the periphery of the vanes, may engage the bracket 28 or fascia main body 14 when the vanes 16 are in their closed positions to mostly or fully close the fascia openings 18.

To move the vanes 16 to and between their closed and open positions, the active shutter assembly 12 includes an actuator 38, such as an electric motor, that is mounted to the bracket 28 and coupled to the vanes 16 through a drive mechanism 40. The actuator 38 may be connected to a central support wall 42 of the bracket 28 that is located between the bracket openings 30 and that overlaps the fascia main body 14 between the fascia openings 18. While a single actuator 38 is shown as driving both vanes 16 and being located on central support wall 42 of the bracket 28, other arrangements may be used including arrangements with multiple actuators.

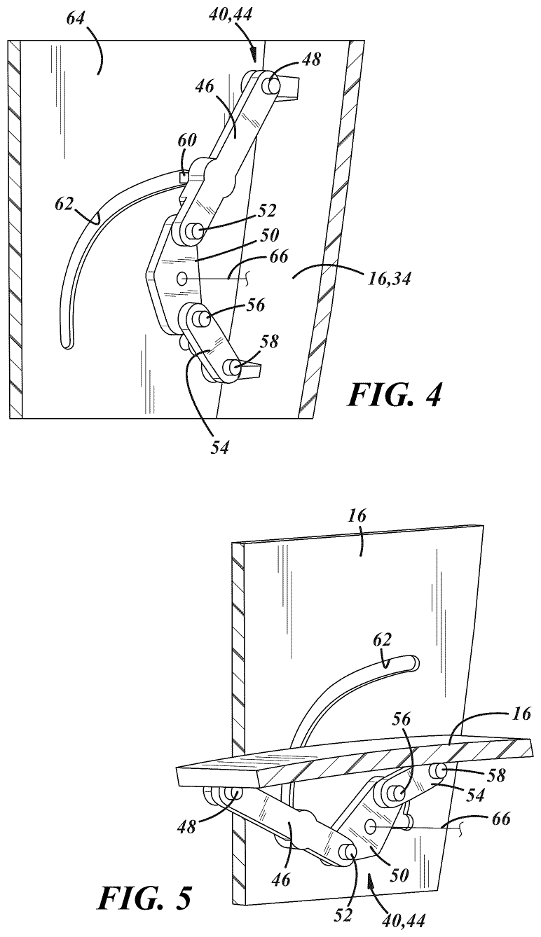

FIGS. 4 and 5 show a drive mechanism 40 defined by a linkage 44 that may be connected to the actuator 38 and to one vane 16 to control motion of the vane 16. A separate linkage 44 may be connected to the actuator 38 and to the other vane 16 to control motion of that vane 16. The linkage 44 defines a 4-bar link mechanism where the vane 16 is a first one of the bars or links. A second bar 46 is coupled to the vane 16 at a first pivot 48 and also is coupled to a third bar 50 at a second pivot 52. The third bar 50 is connected to a fourth bar 54 at a third pivot 56 and is connected to the vane 16 at a fourth pivot 58 that is spaced from the first pivot 48. To control motion of the vane 16, the second bar 46 includes a guide pin 60 that extends laterally (cross-car direction) into a contoured slot 62 formed in a flange 64 of the bracket 28, where the slot 62 defines a path of movement of the second bar 46 which relates to movement of the vane 16 between the open and closed positions. A drive shaft 66 may be connected to the third bar 50 of the linkage 44 of each vane 16, between the second pivot 52 and the third pivot 56. Rotation of the drive shaft 66 by the actuator 38 causes the same and synchronized movement of both vanes 16, to and between the closed position (FIG. 4) and the open position (FIG. 5) of the vanes 16.

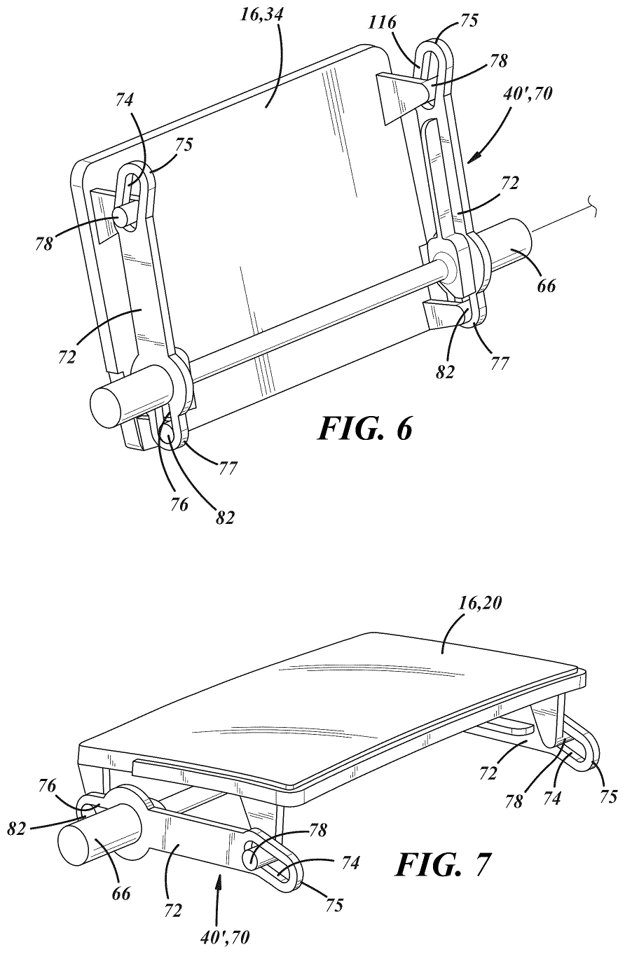

FIGS. 6 and 7 show a different drive mechanism 40′ in the form of a linkage 70 having arms 72 that are rotated by drive shaft 66 which is driven by the actuator 38. Each vane is shown as having a pair of arms 72 and corresponding other features for balanced actuation forces on the vanes 16, but a single arm 72 could be used. The arms 72 include upper slots 74 at a first end 75 and lower slots 76 at a second end 77 of the arms 72, and the arms 72 are coupled to the drive shaft 66 between the ends 75, 77. The vane 16 includes upper pins 78 that are received in the upper slots 74 and lower pins 82 that are received in the lower 76 slots, such that the arms 72 can move and rotate relative to the pins 78, 82. In the example shown, the drive shaft 66 is coupled to the arms 72 closer to the second end 77 and lower slots 76 than the first end 75 and upper slots 74, and the vane 16 rotates such that the first end 75 of the arms 72 and corresponding upper side of the vanes 16 rotate away from the fascia main body 14 when the vanes 16 are moved to the open position. In this way, the extent to which the vanes 16 extend outwardly from the fascia main body 14 can be reduced or eliminated. While only one vane 16 is shown in FIGS. 6 and 7, the same linkage 70 may be provided for the other vane 16, and the same drive shaft 66 may be connected to both linkages 70 to enable synchronized movement of both vanes 16.

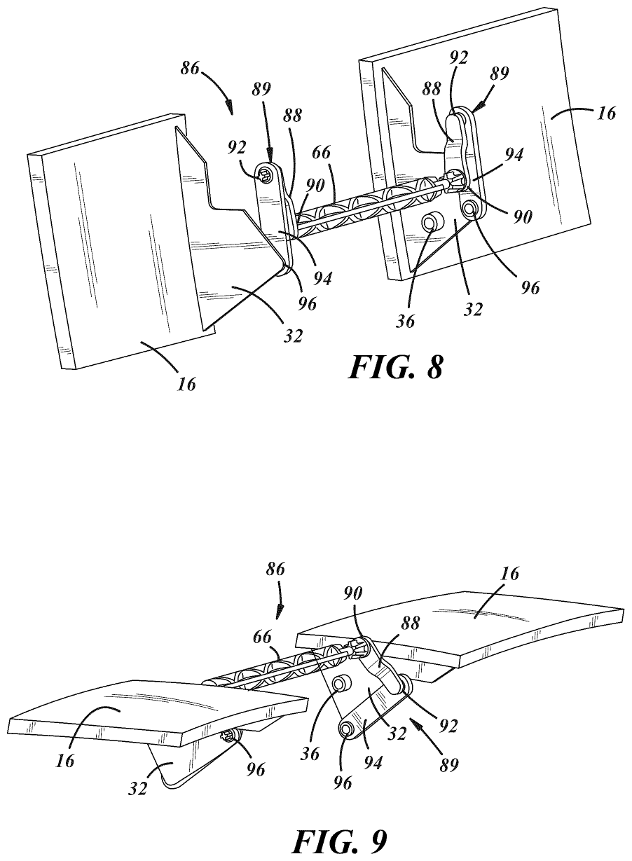

FIGS. 8 and 9 show another drive mechanism 86 by which the vanes 16 may be coupled to the actuator 38. In the mechanism 86, a common rotatable drive shaft 66 is fixed to driven arms 88 of separate linkages 89 for the two vanes 16. The drive shaft 66 is coupled to the driven arms at a first location 90. The driven arms 88 are each pivotally connected at a second location 92, that is spaced from the first location 90, to respective second arms 94. The second arms 94 are, in turn, pivotally connected to the coupling flanges 32 of the vanes 16 at a third location 96 that is spaced from the second location 92. As noted earlier, the coupling flanges 32 are fixed to the vanes 16 and are pivotally connected to the bracket 28 at pivots 36 that are spaced from the third location 96.

In operation, the linkages 89 are arranged so that the vanes 16 are locked against being back driven by exterior forces acting on the vanes 16 (e.g. air flow) and tending to open the vanes 16, when the vanes 16 should be closed. In at least some implementations, when the vanes 16 are in their closed positions, the driven arms 88 and second arms 94 are juxtaposed and substantially parallel to one another, as shown in FIG. 8. In this position, forces acting on and tending to open the vanes 16 act on the flanges 32 at the third locations 96 which may be generally aligned with the pivots 36 and in opposition to the force on the vanes, such that the force on the vanes is unable to rotate the vanes 16 about the pivots 36 in the absence of rotation of the drive shaft 66. When the drive shaft 66 is rotated by the actuator 38, the driven arms 88 push and rotate the second arms 94 about the third locations 96 which in turn rotates the vanes 16 about the pivots 36.

As shown in FIG. 3, the active shutter assembly 12 may be mounted to the main body 14 of the fascia by a bracket 28 received against an inner surface 100 of the main body 14. The bracket 28 may be a single, unitary component wherein the features and portions of the bracket 28 are all formed at the same time, such as by a molding process, or the bracket 28 may include one or more bracket parts coupled together and/or arranged to be mounted directly to the inner surface 100 of the fascia main body 14. Accordingly, in at least some implementations, the support wall 42 to which the actuator 38 is mounted, the pivots 36 to which the vanes 16 are connected, and a peripheral main wall 102 of the bracket 28 in which the bracket openings 30 are formed and by which the bracket 28 is coupled to the fascia main body 14, are all formed and integrated in the same piece of material.

To facilitate connection of the bracket 28 to the fascia main body 14, in at least some implementations such as that shown in FIG. 3, the main body 14 includes alignment and/or attachment structures 104 on the inner surface 100 by which the bracket 28 of the active shutter assembly 12 is properly oriented and connected to the main body 14. In at least some implementations, the bracket 28 is attached directly to the main body 14 by way of coordinating attachment structures 106 of the bracket 28 that are mated, for example, by snap-fit, friction-fit, or otherwise connected with the attachment structures 104 of the fascia main body 14 such as by welds or fasteners. In the example shown in FIG. 3, the fascia main body 14 includes tabs 104 extending outward from the inner surface 100 of the fascia main body 14, and the tabs 104 may include prongs or barbs that are pressed through smaller slots 106 in the bracket 28, where the barbs then overlap the bracket 28 and retain the tabs 104 within the slots 106. Additionally, the fascia main body 14 and bracket 28 have outward/rearwardly extending and overlapped tabs 108, 110 with aligned openings through which a fastener may be received to further connect the bracket 28 to the fascia. Still other mechanical connections can be provided as desired, and, in some implementations, the bracket 28 may also or instead be connected to the fascia main body 14 by welding, bonding or with fasteners independent of mating attachment structures 104, 106.

The bracket 28 has an inner surface 112 that is received against the inner surface 100 of the fascia main body 14. The inner surface 112 of the bracket 28 may include portions that define the bracket openings 30 in which the vanes 16 are mounted and that completely surround the fascia openings 18. The inner surface 112 of the bracket 28 may be defined at least in part by the bracket main wall 102 that, when installed on the fascia main body 14 and with reference to an orientation of the fascia 10 when installed on the vehicle, extends in cross-car directions (e.g. between left and right sides of the vehicle) and vertically (e.g. between a top/roof and a bottom/underside of the vehicle), and has a thickness in a fore-aft orientation (e.g. extending in a direction from the front end to the rear end of the vehicle). The main wall 102 may extend outwardly, in the cross-car directions from the bracket openings 30 and provide surface area of overlap with the inner surface 100 of the fascia main body 14 and via which the bracket 28 may be welded, bonded by adhesives or otherwise coupled to the fascia main body 14 in at least some implementation. The bracket 28 may also have a base flange 114 at a lower end of the main wall 102 that extends away from the main wall 102 and is received over an inwardly extending and complementarily oriented flange 116 of the fascia main body 14, and the overlapped tabs 108, 110 may be provided at outer edges of these flanges 114, 116.

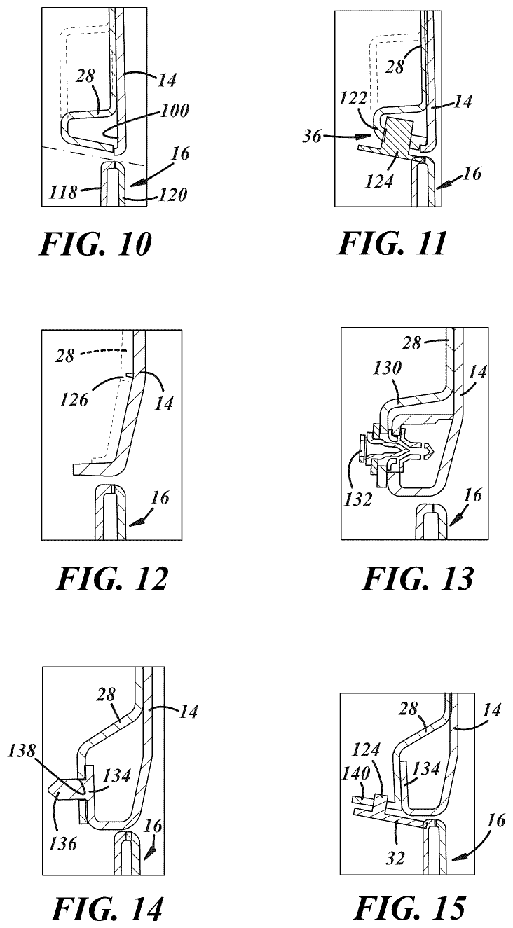

FIGS. 10-21 illustrate representative ways in which the bracket 28 may be connected directly to the fascia main body 14. FIG. 10 shows the bracket 28 welded to an overlapped portion of the inner surface 100 of the fascia main body 14 by way of infrared or ultra-sonic welding or the like. The overlapped portions shown are outboard of and adjacent to one of the bracket openings 30 and fascia openings 18, in which a vane 16 is received. In the implementation shown, the vane 16 is defined by two layers of materials, with an inner layer 118 behind an outer layer 120 that defines the class-A or outer surface 20 of the vane 16 that is visible from outside the vehicle.

As shown in FIG. 11, the bracket 28 may include a doghouse portion 122 that defines the pivot 36 and provides a space in which may be received a post or pin 124 of the vane 16 by which the vane 16 is pivotally connected to the bracket 28.

FIG. 12 shows an alignment protrusion 126 formed on the inner surface 100 of the fascia main body 14, outboard of a flange 128 that defines the fascia opening 18 in which the vane 16 is received. The alignment protrusion 126 can be received in a corresponding cavity in or against a surface of the bracket 28 to facilitate alignment and assembly of the bracket 28 to the fascia main body 14. FIG. 13 shows a doghouse portion 130 provided on the fascia 18 adjacent to an edge of a fascia opening 18, with part of the bracket 28 overlapping the doghouse portion 130. A separate fastener 132 that is received through aligned openings in the bracket 28 and doghouse portion 130 of the fascia main body 14.

FIG. 14 shows an inverted flange 134 of the fascia main body 14 that includes an integrally formed locking protrusion 136. The bracket 28 includes an opening 138 that is aligned with the locking protrusion 136 and, in assembly, the locking protrusion is pressed into the opening to secure the bracket 28 to the fascia main body 14. The locking protrusion 136 may be retained in the opening 138 by an interference fit and/or the locking protrusion may include a barb or similar feature that radially overlaps the bracket 28 after passing through the opening, and thereby resists or prevents unintended removal of the locking protrusion 136 from the bracket opening 138.

FIG. 15 shows an inwardly protruding flange 140 of the bracket 28 that includes an opening in which is received a pivot post or pin 124 on the coupling flange 32 of a vane 16, to couple the vane 16 to the bracket 28. The flange 140 defines part of the bracket opening 30 and extends away from and inward relative to the bracket main wall 102, and the flange 140 may be formed in part of the bracket 28 that overlaps the flange 134 that is also shown in FIG. 14.

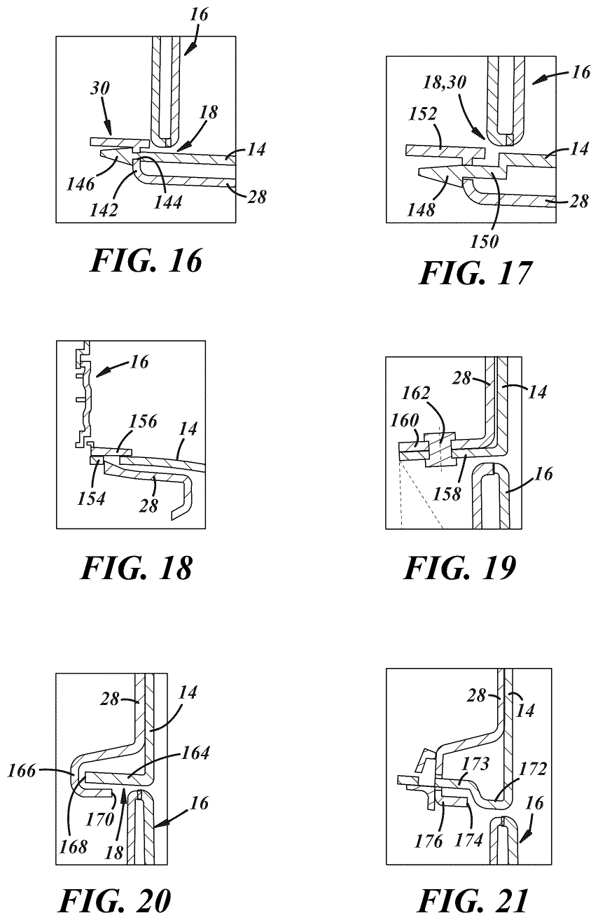

Referring now to FIG. 16, the bracket 28 includes a C-channel 142 with an opening 144 through which a barbed coupling projection 146 of the fascia main body 14 is received, with this connection shown as being adjacent to a lower edge of the bracket and fascia openings 18, 30, and with the vane 16 located above this portion of the bracket 28. FIG. 17 shows a similar connection between the bracket 28 and fascia main body 14 but, in this instance, the barbed coupling projection 148 is located on an offset flange 150 of the fascia main body 14 so that a flange 152 or surface of the bracket 28 and the lower edge of the bracket opening 30 is flush to an adjacent portion of the fascia main body 14. While FIGS. 16 and 17 illustrate connections located behind the vanes 16 in the fore-aft direction, FIG. 18 shows a C-channel 154 and tab 156 connection between the bracket 28 and fascia main body 14 that is located in front of the vanes 16.

Referring now to FIG. 19, the fascia main body 14 is shown with an inwardly extending flange 158 that defines part of the fascia opening 18 for a vane 16. The bracket 28 has a matching flange 160 that overlaps the fascia flange 158 and the flanges may be connected together by a fastener, such as a rivet 162 received in aligned openings of the flanges.

FIG. 20 illustrates an inward flange 164 that defines part of the fascia opening 18 for the vane 16, and which is oriented at an acute included angle, which may require a lifter in the tooling forming the fascia main body 14. The bracket 28 includes a C-channel 166 that is received over the outer end 168 of the flange 164, with the outer end 170 of the C-channel 166 shown as received within and not flush to the fascia opening 18. FIG. 21 shows a similarly located and oriented inward flange 172 of the fascia main body 14 with includes an offset portion 173 such that an outer end 174 of a C-channel 176 of the bracket 28 that is received in the fascia opening 18 behind the vane 16, and is generally flush with the fascia flange 172. In this implementation, the C-channel 176 includes a slot through which the outer end of the fascia flange is received, and a fastener or retainer 178 (e.g. a clip) is pressed over the flange 172 and against the adjacent surface of the bracket C-channel 176.

The various connections and couplings between the bracket 28 and fascia main body 14 can be used independently or in any desired combination to ensure a suitable connection of the bracket 28 to the fascia main body 14. By way of non-limiting examples, different portions may be fastened or clipped or connected by mating snap-fit or press-fit features, while other portions are welded together. Other features may be provided to ensure a proper location and alignment of the bracket 28 relative to the fascia main body 14, without definitively connecting the parts together, before welding or fastening or otherwise connecting the bracket 28 to the fascia main body 14.

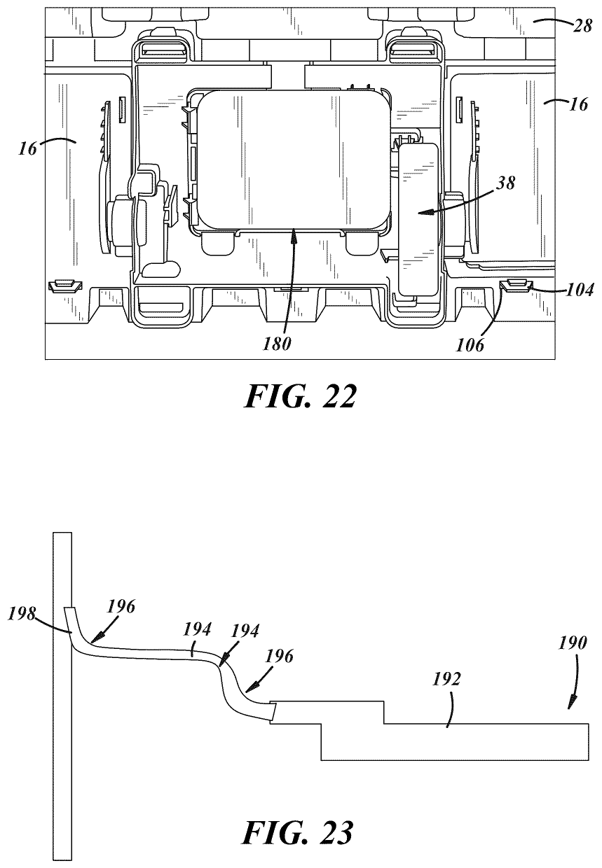

In FIG. 22, an electrically operated sensor 180 is carried by the bracket 28 and, in this implementation, is shown as being connected to the support wall, and located between the support wall 42 and the fascia main body 14, and is thus located between the fascia openings 18 and vanes 16. The sensor 180 may by of the type that emits light or sound waves and receives reflected waves, such as a radar, lidar or ultrasonic sensor sometimes used as object detection sensors in vehicles. So arranged, the sensor 180 may be hidden from view from outside the vehicle and waves emitted and received by the sensor 180 pass through the fascia main body 14. A housing of the sensor 180 may be connected to the bracket 28 in any desired way, such as be snap-fit tabs, fasteners (e.g. screws or clips) and this may be done prior to assembly of the bracket 28 to the fascia main body 14. Likewise, the vanes 16 and the actuator 38 for the vanes 16 may also be connected to the bracket 28 prior to connection of the bracket 28 to the fascia main body 14. In this way, the bracket 28 with the integrated components can be installed as a unitized subassembly on the fascia main body 14, with only wiring harness connections needed to complete the assembly of the active shutter assembly 12 and any sensor(s) carried by the bracket 28.

As shown in FIG. 23, a vane 190 may be formed in two parts with a central body 192 surrounded fully or in part by an outer body 194. The outer body 194 may be integrally molded with and onto the central body 192 and the outer body 194 may be thinner than the central body 192 and/or formed of a more flexible material than the central body 192 and arranged to provide a sealing surface 70 of the vanes 16. The outer body 194 may be contoured to, for example, include surfaces that are curved and that may provide pivoting or flexible areas 196 to permit desired flexing of the outer body 194 as it contacts and seals against the bracket 28 or fascia main body 14, such as is shown at 198. Materials used may include, but are not limited to, polypropylene, TPV, TEO, TPO and the like, and fillers can be utilized.

The bracket 28 with the integrated actuator 38 and vanes 16 can be easily, accurately and securely attached to the fascia main body 14 to enable a cost, time and labor effective solution to inclusion of an active shutter assembly 12 on a fascia. Previously, active shutter assemblies were part of a sizeable frame that defined a large section of the fascia and that was exposed via a corresponding opening in the fascia such that the assembly defined a relatively large portion of the class-A outer surface of the fascia. The bracket 28 enables the vanes 16 to be provided in like-sized openings in the fascia main body 14 with the remainder of the active shutter assembly 12 hidden from view and behind the fascia. Further, the fascia has a more uniform outer surface 22 with only the outer surface 20 of the vanes 16 visible from outside the vehicle, and with the area surrounding the vanes 16 defined by a continuous, one-piece portion of the fascia main body 14. The bracket 28 may be relatively compact and overlap a limited area of the fascia main body 14. In at least some implementations, the bracket 28 may extend outwardly beyond the fascia openings 18, both upward and downward from the fascia opening, a distance less than the vertical dimension of a vane. And the bracket 28 may extend beyond the fascia openings 18 in the cross-car direction a distance less than the cross-car dimension of a vane 16.

In this regard, and as shown in FIGS. 1 and 2, the fascia main body 14 may have a section that includes the active shutter assembly 12 and extends vertically between a lower edge of the fascia main body 14 to a location above the vanes 16, and across the entire cross-car extent of the main body 14. In that section of the main body 14 the fascia may be continuous and one-piece with only the vanes 16 formed from a different piece(s) of material. In the example shown, a grill insert 26 may be provided vertically above and adjacent to the section including the active shutter assembly 12, and headlight covers 202 may also be fitted to the main body 14 spaced from the active shutter assembly 12.

Additionally, the bracket 28 can be formed of a material selected for desired bonding to the inner surface 100 of the fascia main body 14, which may be the same material as that which defines the inner surface 100 of the fascia main body 14. Representative, but not limiting, examples of the materials include Thermoplastic olefin (TPO) which may include various fillers of either talc/mineral, or glass fiber, as well as Polypropylene with glass or other filler content of varying percentages. Because, in at least some implementations, the bracket 28 is not visible from outside the vehicle, the bracket 28 need not have an expensive, class-A outer surface and can be easily bonded or otherwise connected to the fascia main body 14 with all parts of the system pre-assembled to the bracket 28 for easy integration into the fascia. Further, and hidden from view outside the vehicle, the bracket 28 can have reinforcing flanges and ribs and the like that improve the structural integrity of the bracket 28 and may also reinforce and support the corresponding portion of the fascia main body 14.

The above description is intended to be illustrative and not restrictive. Many implementations and applications other than the examples provided would be apparent to those of skill in the art upon reading the above description. The scope of the invention should be determined, not with reference to the above description, but instead with reference to the appended claims, along with the full scope of equivalents to which such claims are entitled. It is anticipated and intended that future developments will occur in the arts discussed herein, and that the disclosed assemblies and methods will be incorporated into such future embodiments. In sum, it should be understood that the invention is capable of modification and variation that is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. In the preceding description, various operating parameters and components are described for one or more exemplary embodiments. These specific parameters and components are included as examples and are not meant to be limiting.

Reference in the preceding description “one example,” “an example,” “one embodiment,” “an embodiment”, “an implementation” or “at least some implementations” means that a particular feature, structure, or characteristic described in connection with the example is included in at least one example or implementation including one or more but not necessarily all innovative features or components. References to various examples, embodiments or implementations do not necessarily refer to the same example, embodiment or implementation each time it appears.

1. A fascia for a vehicle, comprising:
a main body including a fascia opening and multiple attachment or alignment structures; and
an active shutter assembly including a bracket attached directly to the fascia via the multiple attachment or alignment structures, the active shutter assembly also including an actuator coupled to the bracket and a vane that is coupled to the bracket and to the actuator, and wherein the vane is located in or adjacent to the fascia opening and the actuator is operable to move the vane relative to the main body between a first position and a second position in which greater airflow is permitted through the fascia opening than when the vane is in the first position.

2. The fascia of claim 1 wherein the bracket is made of the same material as the main body.

3. The fascia of claim 2 wherein the main body has an outer surface that is adapted to define part of an exterior of a vehicle and an inner surface on an opposite side of the main body from the outer surface, and wherein the bracket is welded to the inner surface of the main body.

4. The fascia of claim 1 wherein the bracket and the main body include mating connection features that provide a snap-fit or interference fit connection by which the bracket is at least partially retained to the main body.

5. The fascia of claim 4 wherein the bracket is welded to the main body at locations spaced from the mating connection features.

6. The fascia of claim 1 wherein a doghouse is formed on one of the main body or the bracket and a cooperating structure is formed on the other of the main body or the bracket, and a fastener is used at the doghouse to connect the bracket to the main body.

7. The fascia of claim 1 wherein the main body and the bracket include overlapped flanges and the overlapped flanges are connected together via welding, an adhesive or a fastener.

8. The fascia of claim 1 wherein the bracket includes a bracket opening aligned with the fascia opening, and the vane is pivotally connected to the bracket at the bracket opening so that an outer surface of the vane is visible through the fascia opening at least when the vane is in the first position.

9. The fascia of claim 8 wherein the actuator is coupled to the vane by a drive mechanism including a drive shaft and a linkage, and wherein the vane is coupled to one link of the linkage and the actuator is coupled to the drive shaft which is coupled to another link of the linkage so that, upon rotation of the drive shaft by the actuator, the linkage is driven to move the vane to and between the first position and second position.

10. The fascia of claim 9 wherein the fascia opening is a first fascia opening and the main body includes a second fascia opening spaced from the first fascia opening, the vane is a first vane and the active shutter assembly includes a second vane coupled to the bracket, the first vane is arranged at the first fascia opening and the second vane is arranged at the second fascia opening, and the drive mechanism includes two linkages that are each coupled to the drive shaft and driven by the drive shaft as the drive shaft is rotated to move both the first vane and the second vane relative to the bracket and the main body.

11. The fascia of claim 1 wherein the bracket includes a main wall received against an inner surface of the main body, the main wall includes a bracket opening that is aligned with the fascia opening such that the main wall surrounds the fascia opening, and wherein the vane overlaps the bracket opening and the vane is visible through the fascia opening.

12. The fascia of claim 11 wherein the bracket includes a base flange extending away from the main wall and a portion of the main body that is overlapped by the main wall, and wherein the main body includes flange oriented in the same direction as the base flange and wherein the base flange is connected to the flange of the fascia.

13. The fascia of claim 9 wherein the linkage includes a driven arm connected to the drive shaft at a first location and to a second arm at a second location that is spaced from the first location, and wherein the second arm is connected to the vane at a third location, and wherein the driven arm and second arm are arranged so that, in the first position of the vane, the driven arm and second arm are substantially parallel to one another and arranged to resist movement of the vane away from the first position in the absence of rotation of the drive shaft by the actuator 14. The fascia of claim 1 which also includes an electrically operated sensor coupled to the bracket and arranged between part of the bracket and an inner surface of the main body.

15. The fascia of claim 1 wherein the actuator is coupled to the vane by a drive mechanism including a drive shaft and a four-bar linkage mechanism in which the vane defines one bar of the mechanism and wherein two other bars of the mechanism are connected to the vane.

16. The fascia of claim 1 wherein the main body includes a section in which the fascia openings are located, the section extends vertically above and below the fascia openings and across an entire cross-car extent of the main body and the section is formed in a single, continuous piece.

17. A fascia for a vehicle, comprising:
a main body including multiple fascia openings and multiple attachment or alignment structures; and
an active shutter assembly including a bracket attached directly to the fascia via the multiple attachment or alignment structures, the active shutter assembly also including one or more than one actuator, each of the one or more than one actuator being coupled to the bracket, and multiple vanes coupled to the bracket and to at least one of the one or more than one actuator, and wherein one or more of the multiple vanes are separately located in or adjacent to each of the multiple fascia openings, and one or more than one actuator is operable to move the multiple vanes relative to the main body between a first position and a second position in which greater airflow is permitted through the fascia opening than when the vane is in the first position.

18. The fascia of claim 17 wherein the bracket includes multiple bracket openings defined in a main wall of the bracket and with each bracket opening aligned with a respective one of the multiple fascia openings and with the main wall surrounding each of the multiple fascia openings.

19. The fascia of claim 16 wherein the bracket is made of the same material as an inner surface of the main body, the inner surface is opposite to an outer surface of the main body that is adapted to define part of an exterior of the vehicle, and the bracket is welded to the inner surface.

20. The fascia of claim 16 wherein the bracket and the main body include mating connection features that provide a snap-fit or interference fit connection by which the bracket is at least partially retained to the main body, and wherein the bracket is welded to the main body at locations spaced from the mating connection features.
